(19) United States
(12) Patent Application Publication
(10) Pub. No.: US 2026/0336838 A1
(43) Pub. Date: Oct. 29, 2026

(54) BOLT RELEASE SYSTEM FOR SPACECRAFT AND LAUNCHER SEPARATION SYSTEMS AND SEPARATION SYSTEM COMPRISING SAME

(71) Applicant: AIRBUS DEFENCE AND SPACE, S.A., Madrid (ES)

(72) Inventor: Juan Miguel ANDRES MATEY, Madrid (ES)

(21) Appl. No.: 18/997,484

(22) PCT Filed: Jul. 19, 2022
(86) PCT No.: PCT/ES2022/070470

§ 371 Date: Jan. 21, 2025

(51) Int. Cl. B64G 1/64; F16B 31/00

(52) U.S. Cl. CPC B64G 1/6455; F16B 31/005

(57) ABSTRACT

A bolt release system for spacecraft and launcher separation systems, including a release device (1), a bolt (2) connected to the release device (1) and first retaining device (3), with an end surface (4) and an inner hole and first elastic device, second retaining device (5), with an end surface (6) and an inner hole and second elastic device, a first retaining cap (13) configured to retain the first retaining device (3) in an open position, a second retaining cap (14) configured to retain the second retaining device (5) in an open position, a releasing bolt (9) including an end section (10) with opposed surfaces (11) and a transversal cut (12) between the opposed surfaces (11). The opposed surfaces (11) are complementary to the end surface (4) of the first retaining device (3) and to the end surface (6) of the second retaining device, (5).

### FIELD OF THE INVENTION

The invention refers to a bolt release system, particularly applicable in separations systems, such as launcher separations systems or spacecraft separation systems. The invention also refers to a separation system that comprises such bolt release system.

### BACKGROUND OF THE INVENTION

Since the beginning of the development of technologies for carrying loads to outer space many connection and separation systems have been developed for the different structures or phases which make up a carry vehicle and particularly for that which joins the latter to its payload or satellite. Connections based on pyrotechnic strings or explosive bolts are effective and reliable but they generate high levels of vibratory disturbance or shocks which move along the whole vehicle until reaching the most sensitive elements. Thus these kinds of connections are usually reserved for vehicle phase separations which are far from the satellite. In order to separate the satellite, systems are needed which, while maintaining their joining effectiveness, do not produce disturbing effects on separation such as those described.

Connection-separation elements have been developed based on preloading a joining support by means of a cable or bolt which is subsequently cut with a pyrotechnic cutter or thermal knife, or rather two previously cut ends are separated with a pyrotechnic nut or an electromechanical nut.

Systems based on prior technology normally used two tension band halves joined by two bolts to be cut by two pyrotechnic elements. This arrangement with a plane of symmetry slightly improves the generation of disturbance by reducing the excitability of the axial symmetry vibration mode, but still maintains a great capacity for exciting these modes, even more so taking into account that steel bands with a small cross section and at high tension, that is, very stretched, are used and therefore tension relaxation is very fast and very symmetrical.

These systems yet entail a very high shock, are not refurbishable as cut bolt needs replacement and could present a contamination issue due to the production of cut bolt debris.

The working principle is that the highly preloaded bolt is cut off by a pyro-cutter at the desired release point. There are a limited number of pyro-cutters in the market for space environment use and with the requested high performances.

Currently designed band type separation systems would require a design adjustment to more commercial high load separation devices, but they imply costly and long activities and sometimes unaffordability due to request for new qualification of the whole system after modifications.

Accordingly, there is a need to provide a bolt release system for spacecraft and launcher separation systems which causes a lower release shock than the existing systems.

### SUMMARY OF THE INVENTION

The object of the invention is to provide a bolt release system for spacecraft and launcher separation systems that overcomes the mentioned drawbacks.

The invention provides a bolt release system for spacecraft and launcher separation systems that comprises:
a release device,
a bolt connected to the release device and protruding from it,
first retaining means, adjacent to the release device, with at least one end surface and an inner hole,
second retaining means, distal from the release device, with at least one end surface and an inner hole,
a first elastic means configured to act on the first retaining means,
a second elastic means configured to act on the second retaining means,
a first retaining cap that surrounds at least partially the first retaining means and comprising joining means, the first retaining cap being configured to retain the first retaining means in an open position of the bolt release system,
a second retaining cap that surrounds at least partially the second retaining means and comprising joining means, the second retaining cap configured to retain the second retaining means in an open position of the bolt release system,
a releasing bolt, comprising an end section with opposed surfaces and a transversal cut in its most extreme position between the opposed surfaces,
such that:
the opposed surfaces of the end section of the releasing bolt are complementary to at least one end surface of the first retaining means and to at least one end surface of the second retaining means, such that the corresponding complementary surfaces are configured to be able to fit with each other as mating surfaces, and in a closed position of the bolt release system the end section with opposed surfaces is coupled and retained between one end surface of the first retaining means and one end surface of the second retaining means, and the bolt connected to the release device crosses the inner hole of the first retaining means, the end section with opposed surfaces of the releasing bolt and the inner hole of the second retaining means.

The main advantages of the invention with respect to the prior art devices are the following ones:
Interchangeability with bolt-cutters to the system of the invention with equal load performance and release capability due to mechanical and electrical I/F similarity.
A lesser load performance and hence lower cost release device could be used.
The system of the invention is refurbishable as the release bolt is not destroyed in every actuation.
It eliminates dependence on a specific high performance bolt-cutter provider, enables to choose in a greater availability of lesser performance release devices from different providers (NEA, pyronuts, linear actuators, etc). It reduces the dependence on existing commercial pyro-cutters.
Lower shock is generated compared to most of the conventional systems
No debris are generated, as the release bolt is intact after release.

The invention also provides separation systems comprising bolt release systems, as per claims 10 and 11.

Other characteristics and advantages of the present invention will be clear from the following detailed description of several embodiments illustrative of its object in relation to the attached figures.

### BRIEF DESCRIPTION OF DRAWINGS

FIG. 1 shows a perspective view of a band space separation system.

FIG. 2 shows a schematic representation of a prior art separation system using pyrotechnic cutters.

FIG. 3 shows a schematic representation of a separation system of the invention, including the bolt release system.

FIG. 4 shows another view of a separation system of the invention, including the bolt release system in its closed position.

FIG. 5 shows the separation system of the invention, including the bolt release system in its open position.

FIG. 6 shows a representation of the bolt release system of the invention in a closed position and with the first and second retaining caps.

FIG. 7 shows a representation of the bolt release system of the invention in a closed position.

FIG. 8 shows a representation of the bolt release system of the invention in an open position, after triggering.

FIG. 9 shows a perspective view of a separation system with a plurality of hold-down and release devices.

### DETAILED DESCRIPTION OF THE INVENTION

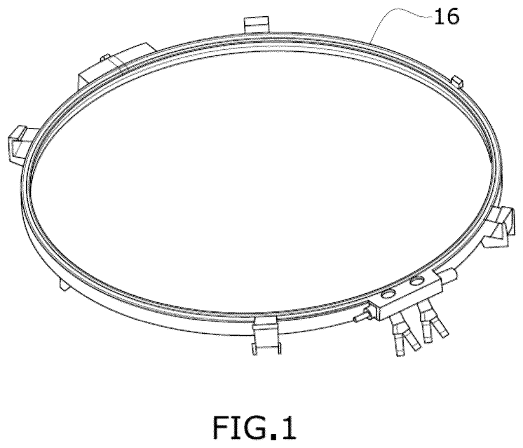

FIG. 1 shows a band type separation system, with a band 16 with two halves, such that the halves are joined at their ends by conventional release systems.

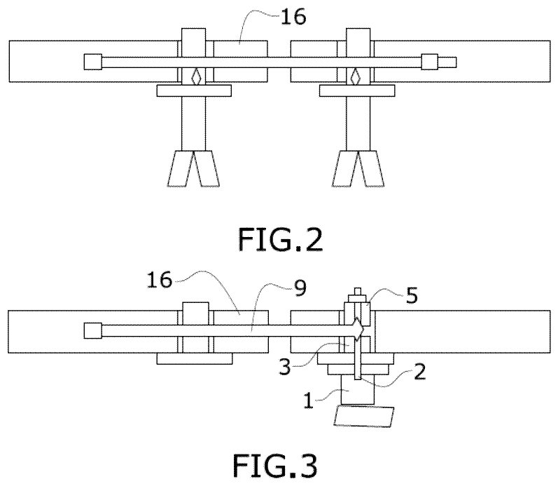

The conventional release systems can be pyrotechnic cutters as the ones shown in FIG. 2. A highly preloaded bolt (the releasing bolt) is cut off by a pyro-cutter at the desired release point, so the halves of the band 16 are separated.

FIG. 3 shows a schematic representation of a separation system of the invention, including the bolt release system of the invention.

The bolt release system for spacecraft and launcher separation systems comprises the following elements:
a release device 1,
a bolt 2 connected to the release device 1 and protruding from it,
first retaining means 3, adjacent to the release device 1, with at least one end surface 4 and an inner hole,
second retaining means 5, distal from the release device, with at least one end surface 6 and an inner hole,
a first elastic means configured to act on the first retaining means 3,
a second elastic means configured to act on the second retaining means 5,
a first retaining cap 13 that surrounds at least partially the first retaining means 3 and comprising joining means, the first retaining cap 13 being configured to retain the first retaining means 3 in an open position of the bolt release system,
a second retaining cap 14 that surrounds at least partially the second retaining means 5 and comprising joining means, the second retaining cap 14 configured to retain the second retaining means 5 in an open position of the bolt release system,
a releasing bolt 9, comprising an end section 10 with opposed surfaces 11 and a transversal cut 12 in its most extreme position between the opposed surfaces 11,
   such that the opposed surfaces 11 of the end section 10 of the releasing bolt 9 are complementary to at least one end surface 4 of the first retaining means 3 and to at least one end surface 6 of the second retaining means 5, such that the corresponding complementary surfaces are configured to be able to fit with each other as mating surfaces, and in a closed position of the bolt release system the end section 10 with opposed surfaces 11 is coupled and retained between one end surface 4 of the first retaining means 3 and one end surface 6 of the second retaining means 5, and the bolt 2 connected to the release device 1 crosses the inner hole of the first retaining means 3, the end section 10 with opposed surfaces 11 of the releasing bolt 9 and the inner hole of the second retaining means 5.

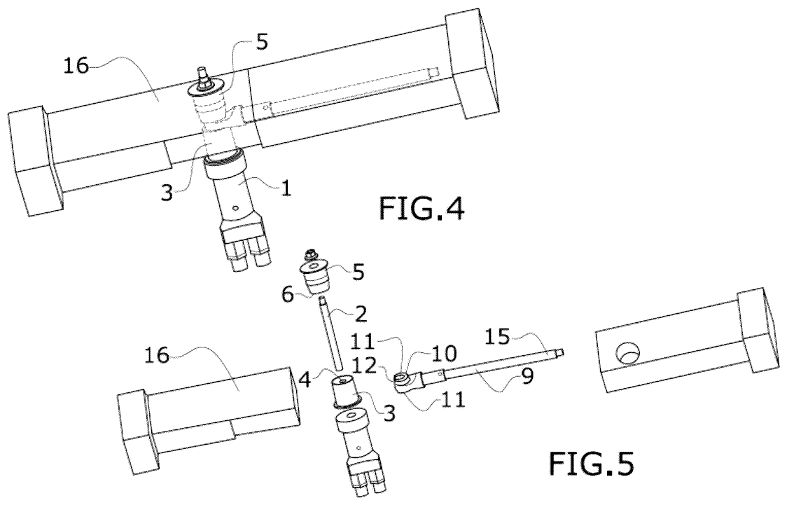

FIGS. 3 and 4 show a separation system, that comprises a band 16 with two halves and release systems of the invention. The figure shows a release system of the invention that joins two ends of the corresponding halves of the band 16.

In the embodiment of the bolt release system of FIG. 5, the opposed surfaces 11 of the end section 10 of the releasing bolt 9 are convex, and the corresponding end surface 4 of the first retaining means 3 and the corresponding end surface 6 of the second retaining means 5 are concave.

In FIG. 5 it can be seen that after the release device is activated, the bolt 2 (also called “pyrobolt”) is released, and the first elastic means (for instance, a spring) acts on the first retaining means 3, and the second elastic means (for instance, a spring) acts on the second retaining means 5. Accordingly, the convex surfaces of one end of the releasing bolt 9 are not any longer retained between the corresponding end concave surface of the first retaining means 3 and the corresponding end concave surface of the second retaining means 5, so the releasing bolt 9is released, and the halves of the band 16 are separated.

In another embodiment of the bolt release system (not shown), the opposed surfaces 11 of the end section 10 of the releasing bolt 9 are concave and the corresponding end surface 4 of the first retaining means 3 and the corresponding end surface 6 of the second retaining means 5 are convex.

In any of the above embodiments, the end surfaces 4, 6 of the first retaining means 3 and of the second retaining means 5, and the opposed surfaces 11 of the releasing bolt 9 can be frustoconical, so that the convex and the concave surfaces are configured to fit together as mating surfaces.

In another embodiment of the bolt release system (not shown), the opposed surfaces 11 of the end section 10 of the releasing bolt 9 and the corresponding end surface 4 of the first retaining means 3 and the corresponding end surface 6 of the second retaining means 5 are flat surfaces.

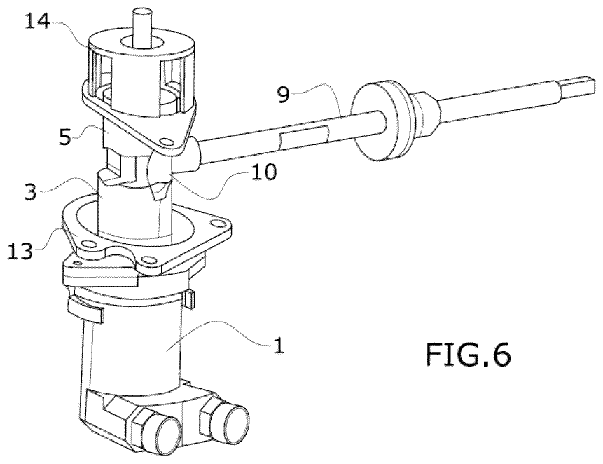

FIG. 6 shows a representation of the bolt release system of the invention in a closed position. In this FIG. 6 the first retaining cap 13 and the second retaining cap 14 are shown. These retaining caps 13, 14 have joining means (not shown) that allow the union of the retaining caps 13, 14 with the band 16 (when the separation system comprises a band 16). In this way, when the bolt release system is triggered and reaches its open position (as in FIG. 5) the first retaining means 3 and the second retaining means 5 are retained and no debris is generated.

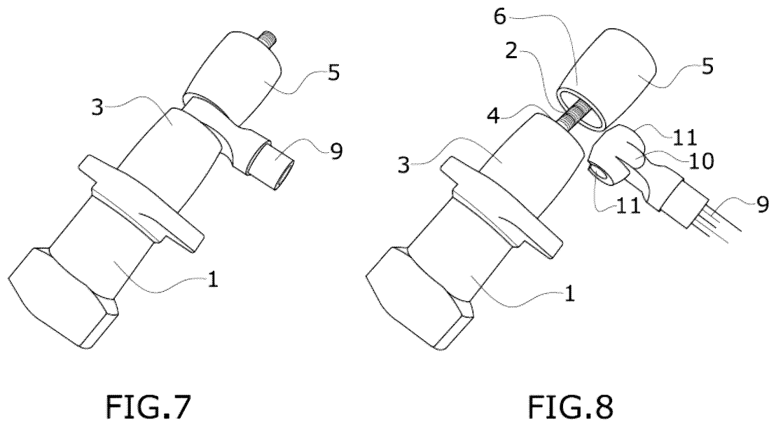

FIG. 7 shows a representation of the bolt release system of the invention in a closed position and FIG. 8 shows a representation of the bolt release system of the invention in an open position, after triggering.

In order to show more clearly how the invention works, the system shown in the FIGS. 4, 5, 7 and 8 does not show the first retaining cap 13 and the second retaining cap 14, which are nevertheless part of the bolt release system, as shown in FIG. 6.

The release device 1 can be a pyrotechnic nut, a Non Explosive Actuator (NEA) or a linear actuator.

In an embodiment, in the releasing bolt 9 the opposite end to the end 10 with opposed convex surfaces 11 has a threaded section 15. The retaining means 3, 5 can be any suitable elements, such as a lower cap (proximal to the release device 1) and an upper cap (distal from the release device 1).

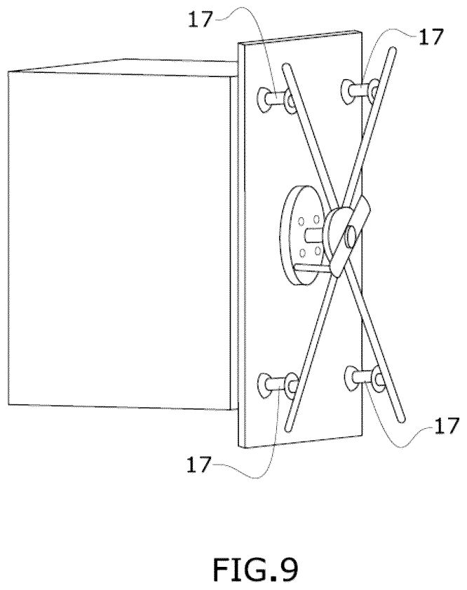

FIG. 9 shows a perspective view of another separation system with a plurality of hold-down and release devices 17. Each hold-down and release device 17 comprises a release bolt, and additionally comprises a bolt release system of any embodiment of the invention. The first retaining cap and the second retaining cap are joined to the hold-down and release device 17 by respective joining means.

Although the present invention has been fully described in connection with preferred embodiments, it is evident that modifications may be introduced within the scope thereof, not considering this as limited by these embodiments, but by the contents of the following claims.

1. A bolt release system for spacecraft and launcher separation systems, the bolt release system comprising:
a release device,
a bolt connected to the release device, the bolt protrudes from the release device,
a first retaining means, adjacent to the release device, wherein the first retaining means includes at least one end surface and an inner hole,
a second retaining means, distal from the release device, wherein the second retaining means includes, at least one end surface and an inner hole,
a first elastic means configured to act on the first retaining means,
a second elastic means configured to act on the second retaining means,
a first retaining cap that surrounds at least partially the first retaining means, wherein the first retaining cap includes a first joining means, and the first retaining cap being configured to retain the first retaining means in an open position of the bolt release system,
a second retaining cap that surrounds at least partially the second retaining means, the second retaining cap includes a second joining means, and the second retaining cap is configured to retain the second retaining means in an open position of the bolt release system,
a releasing bolt including an end section with opposed surfaces and a transversal cut in its most extreme position between the opposed surfaces,
wherein the opposed surfaces of the end section of the releasing bolt are complementary to at least one end surface of the first retaining means and to at least one end surface of the second retaining means, such that the corresponding complementary surfaces are configured to be able to fit with each other as mating surfaces, and in a closed position of the bolt release system the end section with opposed surfaces is coupled and retained between one end surface of the first retaining means and one end surface of the second retaining means, and the bolt connected to the release device crosses the inner hole of the first retaining means, the end section with opposed surfaces of the releasing bolt and the inner hole of the second retaining means.

2. The bolt release system for spacecraft and launcher separation systems according to claim 1, wherein the release device includes a pyrotechnic nut.

3. The bolt release system for spacecraft and launcher separation systems according to claim 1, wherein the release device includes a Non Explosive Actuator.

4. The bolt release system for spacecraft and launcher separation systems according to claim 1, wherein the release device includes a linear actuator

5. The bolt release system for spacecraft and launcher separation systems according to claim 1, wherein in the releasing bolt the opposite end to the end with opposed surfaces has a threaded section.

6. The bolt release system for spacecraft and launcher separation systems according to claim 1, wherein the opposed surfaces of the end section of the releasing bolt are convex and the at least one end surface of the first retaining means and the at least one end surface of the second retaining means are concave.

7. The bolt release system for spacecraft and launcher separation systems according to claim 1, wherein the opposed surfaces of the end section of the releasing bolt are concave and the at least one end surface of the first retaining means and the at least one end surface (6) of the second retaining means are convex.

8. The bolt release system for spacecraft and launcher separation systems according to claim 6, wherein the end surfaces of the first retaining means and of the second retaining means, and the opposed surfaces of the releasing bolt are frustoconical.

9. The bolt release system for spacecraft and launcher separation systems according to claim 1, wherein the opposed surfaces of the end section of the releasing bolt and the at least one end surface of the first retaining means and the at least one end surface of the second retaining means are flat surfaces.

10. A separation system comprising:
a band with two halves, such that the halves are joined at their ends by bolt release systems of claim 1, the first retaining cap and the second retaining cap being joined to the band by respective joining means.

11. A separation system comprising:
a plurality of hold-down and release devices with a release bolt, wherein the plurality of hold-down and release device each include a bolt release system of claim 1, and
wherein in each of the bolt release systems the first retaining cap and the second retaining cap are each joined to a respective one of the hold-down and release devices by respective joining means.

12. A separation system for a spacecraft, the separation system comprising:
a band including a band first end portion and a band second end portion opposing the band first end portion, wherein the band forms a substantially closed loop when the band first end portion and the band second end portion are joined, and the band is configured to releasably secure components of the spacecraft;
a release bolt extending into the band first end portion and including a bolt first end portion joined to the band first end portion and a bolt second end portion including an aperture and annular surfaces around the aperture on opposite sides of the bolt second end portion;
a release device extending through the second end portion of the band and releasably attached to the release bolt to join the first end portion to the second end portion;
the release device includes a second bolt extending through the aperture in the release bolt to join the release device to the release bolt, wherein the second bolt is configured to be removed from the aperture to release the second band end portion from both the release bolt and the first band end portion;
a first annular retaining device including a first end annular surface configured to abut a first annular surface of the annular surfaces around the aperture, wherein the first annular retaining device includes an aperture through which extends the second bolt; and
a second annular retaining device including a second end annular surface configured to abut a second annular surface of the annular surfaces around the aperture, wherein the second annular retaining device includes an aperture through which extends the second bolt.

13. The separation system according to claim 12, wherein the release bolt is aligned in a plane defined by the closed loop of the band, and wherein the second bolt is perpendicular to the release bolt.

14. The separation system according to claim 12, wherein the second bolt is a pyrobolt.

15. The separation system according to claim 12, wherein the first annular retaining device is secured to the second bolt by a pyrotechnic nut engaged with an end of the second bolt and the first annular retaining device is spring biased against the first annular surface of the aperture of the release bolt.

16. The separation system according to claim 15, wherein the second annular retaining device is spring biased against the second annular surface of the aperture of the release bolt.

17. The separation system according to claim 12, wherein the first annular surface of first retaining means is convex and seats in a concave surface of the first annular surface around the aperture of the release bolt, and
wherein the second annular surface of the second annular retaining means is convex and seats in a concave surface of the second annular surface around the aperture of the release bolt.
